(19) United States
(12) Patent Application Publication
(10) Pub. No.: US 2005/0234628 A1
(43) Pub. Date: Oct. 20, 2005

(54) Method for determining a maximum coefficient of friction

(76) Inventors: Ulrich Luders, Wiesbaden (DE); Rainer Oehler, Darmstadt (DE); Thomas Raste, Oberursel (DE); Hubertus Raitz von Frentz, Kronberg (DE)

Correspondence Address: Robert P Seitter;RatnerPrestia, One Westlakes Berwyn Suite 301, PO Box 980, Valley Forge, PA, 19483-0980, US

(21) Appl. No.: 10/506,268

(22) PCT Filed: Feb. 26, 2003
(86) PCT No.: PCT/EP03/01967

§ 371 Date: Jun. 9, 2005

(30) Foreign Application Priority Data
Mar. 1, 2002 (DE) 102 08 815.2

(51) Int. Cl. G05D 1/00

(52) U.S. Cl. 701/80

(57) ABSTRACT

Currently available driving dynamics control systems such as ESP or TCS require in the driving dynamics limit range information about the actual maximum coefficient of friction between tires and roadway to function reliably. A proven approach is to use, once the control is active, the actual utilization of grip as the maximum coefficient of friction. The object of the invention relates to a method for determining the actual maximum coefficient of friction independently of the activation of the control. The method permanently determines values which are representative of the utilization of grip in longitudinal and/or lateral direction, based on measured and/or estimated variables that represent the actual longitudinal forces, lateral forces and vertical forces acting upon the individual wheels and tires, while using measured or calculated actual state variables representative of the tire slip angle and/or the tire slip angle velocity and/or the longitudinal slip and/or the longitudinal slip velocity. The determined values are compared to threshold values and sent to an evaluation unit for defining the maximum coefficient of friction by including further auxiliary variables when the comparison results fall below the threshold values.

The present invention relates to a method for determining a maximum coefficient of friction between tires and roadway of a vehicle from information about force occurring in the contact between tires and roadway.

### INTRODUCTION AND PRIOR ART

Currently available driving dynamic control systems such as ESP (Electronic Stability Program) or TCS (Traction Control System) require in the driving dynamics limit range information about the actual maximum coefficient of friction between tires and roadway to function reliably. A proven approach is to use, once the control is active, the actual utilization of grip as the maximum coefficient of friction (WO 96/16851).

According to the invention, this object is achieved in that a generic method is so implemented that values are permanently determined which are representative of the utilization of grip in longitudinal and/or lateral direction, based on measured and/or estimated variables that represent the actual longitudinal forces, lateral forces and vertical forces acting upon the individual wheels and tires, while including measured or calculated actual state variables representative of the tire slip angle and/or the tire slip angle velocity and/or the longitudinal slip and/or the longitudinal slip speed, and the determined values are compared to threshold values and sent to an evaluation unit for defining the maximum coefficient of friction by including further auxiliary variables such as longitudinal force, lateral force, vertical force, longitudinal acceleration, lateral acceleration, vehicle mass, and/or controlled variables when the comparison results fall below the threshold values. Included in the method are further auxiliary variables and/or controlled variables such as yaw rate, yaw acceleration, steering angle speed, wheel rotational speed and acceleration, longitudinal speed, longitudinal acceleration, lateral acceleration, as the case may be, engine rotational speed, engine torque, moment of inertia of the engine, efficiency, moment of inertia of the wheel, wheel radius, and brake pressure which are taken into account for determining the forces, the slip variation and/or variation of the tire slip angle.

Advantageously, the method for determining the actual maximum coefficient of friction is independent upon the entry into the control. A coefficient of friction that is estimated this way can favorably be used for detecting the driving-dynamics limit range. This renders extended ESP functionalities possible, such as sideslip angle control, or TCS functionalities.

The method is characterized by the steps of:
determining gradients of the utilization of grip between tires and roadway in a longitudinal direction as a function of slip or slip velocity,
determining gradients of the utilization of grip between tires and roadway in a transverse direction as a function of the tire slip angle or the tire slip angle velocity,
comparing the gradients with threshold values and determining the maximum coefficient of friction from the longitudinal, lateral, vertical forces or the longitudinal forces, the vertical forces, the lateral acceleration, the longitudinal acceleration, the vehicle mass, and/or controlled variables when the comparison result falls below the threshold values.

When a comparison result is determined where the determined value does not fall below the threshold value, an equivalent value μ₀ is used as the coefficient of friction. The equivalent value is preferably μ₀=1.

To preclude variations of gradients due to varying vertical forces F_{z}, the gradients are determined from the longitudinal and/or lateral forces of at least one wheel or at least one vehicle axle standardized with the vertical forces and the tire slip angle or the tire slip angle velocity or the slip or the slip velocity of at least one wheel. Advantageously, the gradients are determined from the longitudinal force of at least one vehicle that is standardized with the vertical forces according to the relation

$$\begin{matrix}{C}_{x , VA / HA} = \frac{Δ {F}_{x , n , VA / HA}}{{T}_{A}} \cdot \frac{1}{{\dot{λ}}_{VA / HA}} \cdot with & equation ( 2.9 ) \\ {F}_{x , n , VA / HA} = \frac{{F}_{x , VA / HA}}{{F}_{z , VA / HA}} & equation ( 2.6 )\end{matrix}$$

wherein the longitudinal forces of the front axle of the vehicle are determined according to

$${F}_{x , VA} = \frac{1}{r} ( - {K}_{B , VA} {p}_{B , VA} - 2 {J}_{R} {\dot{ω}}_{R , VA} ) \qquad equation ( 2.7 )$$

and/or the longitudinal forces of the rear axle of the vehicle are determined according to

$${F}_{x , HA} = \frac{1}{r} ( {M}_{M} {ⅈ}_{g} η - {K}_{B , HA} {p}_{B , HA} - \\ ( 2 {J}_{R} + {J}_{M} {i}_{g}^{2} ) {\dot{ω}}_{R , HA} ) . \qquad equation ( 2.8 )$$

The gradients are determined from the lateral force of at least one vehicle axle standardized with the vertical forces according to the relation

$${C}_{y , VA / HA} = - \frac{{\dot{a}}_{y , VA / HA}}{g} \cdot \frac{1}{\dot{α}} . \qquad equation ( 2.11 )$$

Advantageously, the longitudinal-force/circumferential-slip gradients for at least one wheel are determined according to the relation

$${C}_{x} = \frac{\partial {F}_{x , n}}{\partial λ} = \frac{ⅆ {F}_{x , n}}{ⅆ t} \cdot \frac{ⅆ t}{ⅆ λ} \approx \frac{Δ {F}_{x , n}}{{T}_{A}} \cdot \frac{1}{\dot{λ}} . \qquad equation ( 2.3 )$$

and/or the lateral-force/tire-slip-angle gradients for at least one wheel are determined according to the relation

$${C}_{y} = - \frac{\partial {F}_{y , n}}{\partial α} = - \frac{ⅆ {F}_{y , n}}{ⅆ t} \cdot \frac{ⅆ t}{ⅆ α} \approx - \frac{Δ {F}_{y , n}}{{T}_{A}} \cdot \frac{1}{\dot{α}} . \qquad equation ( 2.5 )$$

It is expedient that the vertical forces are determined in a model-based fashion according to the relation

$${F}_{z\_vl} = \frac{m}{( {l}_{v} + {l}_{h} )} ( {l}_{h} g - {ha}_{x} ) ( \frac{1}{2} - \frac{h}{( {b}_{vl} + {b}_{vr} ) g} {a}_{y} ) \\ {F}_{z\_vr} = \frac{m}{( {l}_{v} + {l}_{h} )} ( {l}_{h} g - {ha}_{x} ) ( \frac{1}{2} + \frac{h}{( {b}_{vl} + {b}_{vr} ) g} {a}_{y} ) \\ {F}_{z\_hl} = \frac{m}{( {l}_{v} + {l}_{h} )} ( {l}_{v} g + {ha}_{x} ) ( \frac{1}{2} - \frac{h}{( {b}_{hl} + {b}_{hr} ) g} {a}_{y} ) \\ {F}_{z\_hr} = \frac{m}{( {l}_{v} + {l}_{h} )} ( {l}_{v} g + {ha}_{x} ) ( \frac{1}{2} + \frac{h}{( {b}_{hl} + {b}_{hr} ) g} {a}_{y} ) \qquad equation ( 1.1 )$$

The vertical forces of an axle result from the sum of the vertical forces of the wheels of an axle. The model-based determination of the vertical forces from driving and vehicle state variables is favorable because it obviates the need for sensors for sensing the vertical forces.

Further, it is favorable that the maximum utilization of grip is determined for each individual wheel according to the relation

$$μ = \frac{\sqrt{{F}_{x}^{2} + {F}_{y}^{2}}}{{F}_{z}} \qquad equation ( 2.13 )$$

and the maximum utilization of grip is determined for the rear axle of the vehicle according to the relation

$${μ}_{HA} = \frac{m \sqrt{{a}_{x}^{2} + {a}_{y}^{2}}}{{F}_{z , HA}} - {μ}_{VA} \frac{{F}_{z , VA}}{{F}_{z , HA}} , with \\ {μ}_{VA} = \frac{\sqrt{{F}_{x , VA}^{2} + {F}_{y , VA}^{2}}}{{F}_{z , VA}} \qquad equation ( 2.15 )$$

or for the front axle of the vehicle according to the relation

$${μ}_{VA} = \frac{m \sqrt{{a}_{x}^{2} + {a}_{y}^{2}}}{{F}_{z , VA}} - {μ}_{HA} \frac{{F}_{z , HA}}{{F}_{z , VA}} , with \\ {μ}_{HA} = \frac{\sqrt{{F}_{x , HA}^{2} + {F}_{y , HA}^{2}}}{{F}_{z , HA}} . \qquad equation ( 2.17 )$$

Advantageously, a microcontroller program product is provided which can be loaded directly into the memory of a driving dynamics control, such as ESP, ACT*, ABS (anti-lock system) control, and like systems and comprises software code sections by means of which the steps according to any one of claims 1 to 11 are implemented when the product operates on a microcontroller. The microcontroller program product is stored on a medium suitable for a microcontroller. ‘Microcontroller’ refers to a large-scale integrated component integrating on a chip the microprocessor, program memory, data memory, input and output serial interfaces and periphery functions (such as counter, bus controller, etc.).

Favorable improvements of the invention are indicated in the subclaims.

An embodiment is illustrated in the accompanying drawings and will be described in detail in the following.

In the drawings,

FIG. 1 is a schematic view of the tire forces in a wheel-mounted system of coordinates.

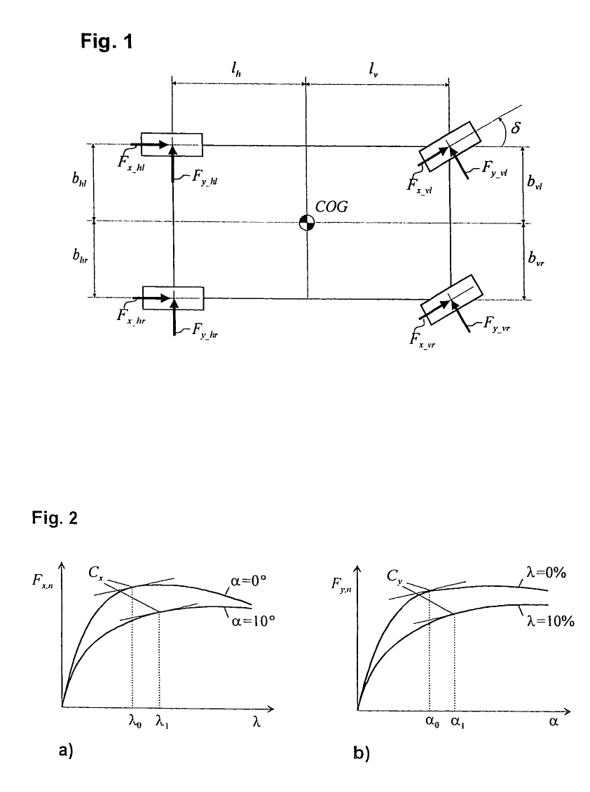

FIG. 2 shows
a) a utilization-of-grip/slip curve
b) a utilization-of-grip/tire-slip-angle curve

FIG. 3 shows a schematic control structure with gradients determined on each wheel.

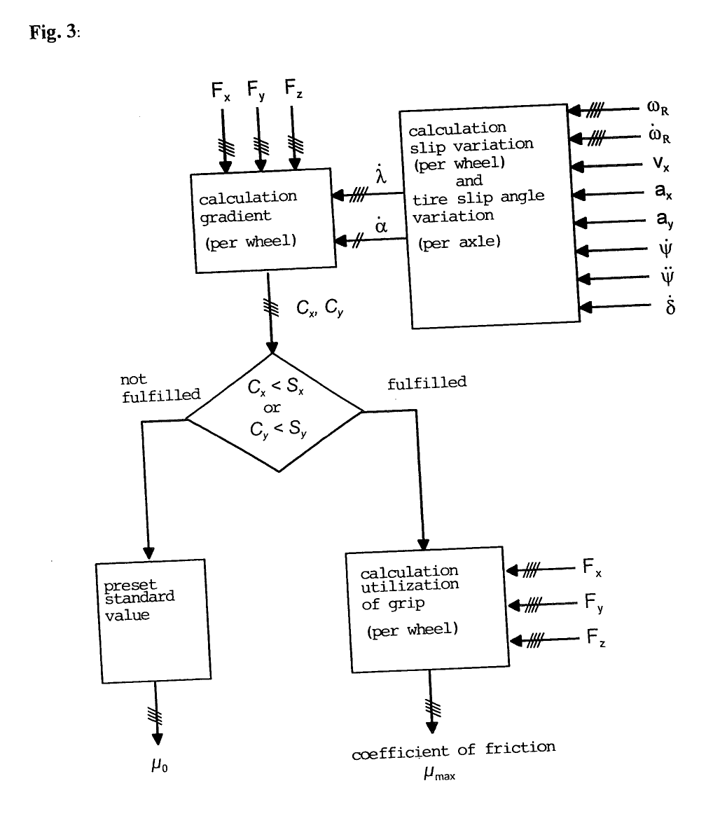

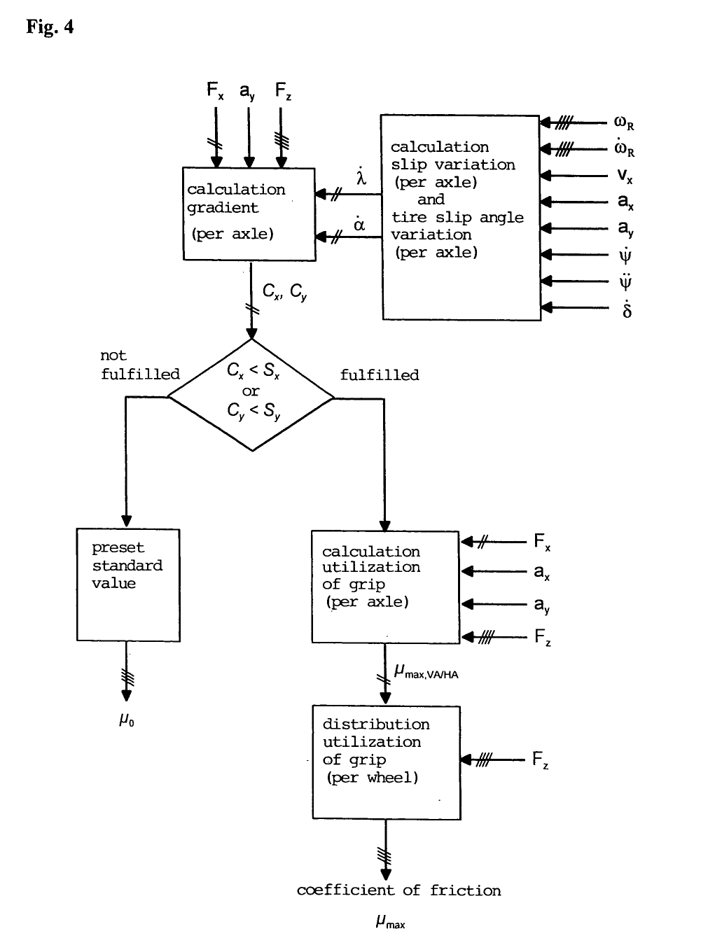

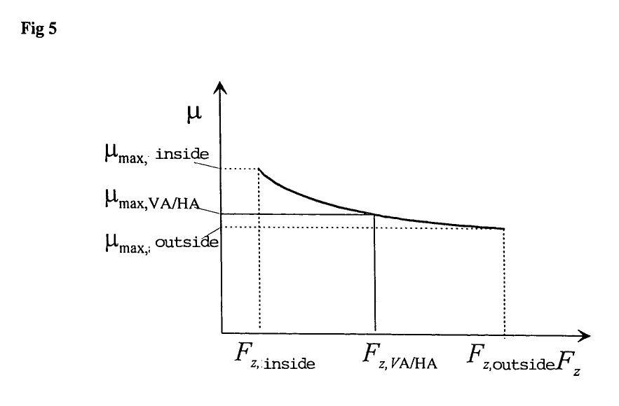

FIG. 4 shows a schematic control structure with gradients determined per axle.

FIG. 5 shows a utilization-of-grip/vertical-force curve.

FIG. 1 illustrates exemplarily the tire forces in the systems of coordinates of a vehicle mounted on the wheels. The forces of the individual wheels that occur at the tires due to the tire/roadway contact can be wheel longitudinal or circumferential forces, transverse forces, and/or vertical wheel forces. FIG. 1 exemplarily depicts wheel longitudinal forces Fₓ and transverse forces F_{y} in the systems of coordinates of a vehicle mounted on the wheels. The forces are designated by indices. There applies
H=rear axle of the vehicle
V=front axle of the vehicle
R=right
L=left
l=distance between the axle and the center of gravity
b=half track of the wheel.

### 2. DESCRIPTION OF THE METHOD

The contact forces of the individual wheels that occur due to the contact between tires and roadway are used for the method. These forces can be produced e.g. by appropriate sensor equipment such as sidewall torsion sensors, force-measuring wheel rims, surface sensors, determination of clamping force/pressure from actuating signals of the brake actuator by way of a mathematical model or measurement of clamping force/pressure of the brake actuator (circumferential forces), spring travel sensors or pressure sensors with pneumatic springs or with a wheel load model based on transverse and longitudinal acceleration information (vertical forces) or can be derived indirectly from vehicle state variables by way of a mathematical model. These forces can be longitudinal wheel forces, transverse forces, and/or vertical wheel forces. As a substitute of said forces, measured or estimated longitudinal accelerations, lateral accelerations, rotational wheel speeds and accelerations as well as engine torque and speed can be used in approximation. The signal information can be utilized either directly or as processed information, e.g. filtered with different time constants.

FIG. 2 shows typical variations of the longitudinal force Fₓ of a tire in dependence on the longitudinal slip λ (FIG. 2a) and the transverse force F_{y} in dependence on the tire slip angle α (FIG. 2b). The method of determining the actual maximum coefficient of friction makes use of the fact that the gradient of these characteristic curves will fall at increasing utilization of grip, i.e., at increasing longitudinal slip λ or tire slip angle α. This applies also to combined loads in longitudinal and transverse directions, e.g. braking operations during cornering. Only the maximums are shifted to higher slip values or tire slip angle values. When any one of the gradients Cₓ or C_{y} drops below defined thresholds, it is assumed that the maximum coefficient of friction between tires and roadway is reached. This analysis can be performed for each individual wheel of a vehicle or also axlewise. The axlewise analysis is preferably realized in maneuvers related to transverse dynamics. Differences in coefficients of friction right and left play a rather insignificant role in transverse-dynamics maneuvers.

The method being shown in its basic structure in FIGS. 3 and 4 is composed of three parts that found on each other.

Calculation of the Gradients Cₓ and C_{y}

(gradient of the tire characteristic curves) from the measured or calculated tire forces Fₓ, F_{y}, F_{z} of at least one wheel or axlewise in approximation of Fₓ from the measured or calculated engine torque, the engine rotational speed, the brake pressure and the rotational wheel speed and acceleration and in approximation of F_{y} from the measured or calculated lateral acceleration a_{y} of at least one vehicle axle, the measured or calculated tire slip angle α or alternatively the tire slip angle velocity α (tire slip angle variation), the measured or calculated longitudinal slip λ or alternatively the slip speed λ (slip variation) of at least one wheel, as well as further auxiliary quantities such as yaw rate \dot{ψ}, yaw acceleration \ddot{ψ}, steering angle δ, steering angle speed \dot{δ}, rotational wheel speed ω_{R}, rotational wheel acceleration \dot{ω}_{R}, the longitudinal speed vₓ, the longitudinal acceleration aₓ as well as the wheel radius r.

Criteria for Determining the Coefficient of Friction μₘₐₓ Between Tire and Roadway.

It is decided by way of comparing the calculated gradients Cₓ or C_{y} with defined thresholds whether the maximum of the utilization of grip prevails and which frictional value is used as coefficient of friction μₘₐₓ.

Calculation of the Coefficient of Friction μₘₐₓ

When the criteria are not fulfilled, there is a standard specification for the coefficient of friction μₘₐₓ=μ₀. When the criteria are fulfilled, then the instantaneously prevailing utilization of grip is used as the coefficient of friction μ_{max,i} per wheel or axlewise as μ_{max,VA/HA}. The prevailing utilization of grip can be determined either directly from the tire forces (Kamm circuit) or indirectly from controlled variables such as longitudinal and lateral acceleration, engine torque, engine rotational speed, brake pressure and wheel rotational speed and acceleration. In an axlewise determination of the coefficient of friction μ_{max,VA/HA}, a distribution of the frictional values is additionally executed in dependence on the measured or calculated vertical wheel forces F_{z,i}.

2.1 Determination of the Gradients Cₓ and C_{y}

2.1.1 Wheelwise Determination of the Gradients from the Tire Forces

To rule out gradient variations due to varying vertical forces F_{z}, the longitudinal and lateral forces are standardized with the vertical force, i.e.

$${F}_{x , n} = \frac{{F}_{x}}{{F}_{z}} , {F}_{y , n} = \frac{{F}_{y}}{{F}_{z}} . \qquad equation ( 2.1 )$$

The vertical forces are either measured or determined in an e.g. model-based manner, e.g. with the vehicle mass m, the height of center of gravity h and the acting lever arms (cf. FIG. 1).

$${F}_{z\_vl} = \frac{m}{( {l}_{v} + {l}_{h} )} ( {l}_{h} g - {ha}_{x} ) ( \frac{1}{2} - \frac{h}{( {b}_{vl} + {b}_{vr} ) g} {a}_{y} ) \\ {F}_{z\_vr} = \frac{m}{( {l}_{v} + {l}_{h} )} ( {l}_{h} g - {ha}_{x} ) ( \frac{1}{2} + \frac{h}{( {b}_{vl} + {b}_{vr} ) g} {a}_{y} ) \\ {F}_{z\_hl} = \frac{m}{( {l}_{v} + {l}_{h} )} ( {l}_{v} g + {ha}_{x} ) ( \frac{1}{2} - \frac{h}{( {b}_{hl} + {b}_{hr} ) g} {a}_{y} ) \\ {F}_{z\_hr} = \frac{m}{( {l}_{v} + {l}_{h} )} ( {l}_{v} g + {ha}_{x} ) ( \frac{1}{2} + \frac{h}{( {b}_{hl} + {b}_{hr} ) g} {a}_{y} ) \qquad equation ( 2.2 )$$

The longitudinal-force/circumferential-slip gradient Cₓ is achieved with the longitudinal slip λ that can be determined from vehicle and wheel speeds according to

$${C}_{x} = \frac{\partial {F}_{x , n}}{\partial λ} = \frac{ⅆ {F}_{x , n}}{ⅆ t} \cdot \frac{ⅆ t}{ⅆ λ} \approx \frac{Δ {F}_{x , n}}{{T}_{A}} \cdot \frac{1}{\dot{λ}} . \qquad equation ( 2.3 )$$

When the slip is not available, the gradient can be determined by means of the slip speed \dot{λ}. The slip speed \dot{λ} can be determined from further auxiliary signals such as the wheel rotational speed ω_{R}, the wheel rotational acceleration \dot{ω}_{R}, the vehicle longitudinal speed vₓ, the vehicle longitudinal acceleration aₓ and the wheel radius r. The quantity T_{A} is the sampling time.

$$\dot{λ} = \frac{{\dot{ω}}_{R} r}{{v}_{x}} - \frac{{ω}_{R} r \cdot {a}_{x}}{{v}_{x}^{2}} \qquad equation ( 2.4 )$$

The lateral-force/tire-slip-angle gradient C_{y} can be determined with a measured or estimated tire slip angle α. When there is no tire slip angle, the tire slip angle velocity \dot{α} can be used to determine the gradient in the form of

$${C}_{y} = - \frac{\partial {F}_{y , n}}{\partial α} = - \frac{ⅆ {F}_{y , n}}{ⅆ t} \cdot \frac{ⅆ t}{ⅆ α} \approx - \frac{Δ {F}_{y , n}}{{T}_{A}} \cdot \frac{1}{\dot{α}} . \qquad equation ( 2.5 )$$

The tire slip angle velocity \dot{α} can be determined from further auxiliary signals, cf. embodiment. The quantity T_{A} is the sampling time.

2.1.2 Axlewise Determination of the Gradients

An axlewise standardized longitudinal force can be calculated from the longitudinal forces and the vertical force of the axle according to

$${F}_{x , n , VA / HA} = \frac{{F}_{x , VA / HA}}{{F}_{z , VA / HA}} . \qquad equation ( 2.6 )$$

In a standard drive, the longitudinal force at the front axle can be calculated in approximation from the brake pressure p_{B,VA} as a sum of the brake pressures at the axle, a proportionality factor K_{B,VA}, the wheel inertia moment J_{R}, the wheel radius r and the wheel rotational acceleration \dot{ω}_{R,VA} (average value of the wheel rotational accelerations of the axle), according to

$${F}_{x , VA} = \frac{1}{r} ( - {K}_{B , VA} {p}_{B , VA} - 2 {J}_{R} {\dot{ω}}_{R , VA} ) . \qquad equation ( 2.7 )$$

The longitudinal force at the rear axle can be calculated in approximation from the brake pressure p_{B,HA} as a sum of the brake pressures at the axle, a proportionality factor K_{B,HA}, the wheel inertia moment J_{R}, the wheel radius r and the wheel rotational acceleration \dot{ω}_{R,HA} (average value of the wheel rotational accelerations of the axle), the engine torque M_{M}, the engine inertia torque J_{M}, the transmission ratio as the ratio between the engine rotational speed and the wheel rotational speed i_{g}=ω_{M}/ω_{R,HA} and the efficiency η, according to

$${F}_{x , HA} = \frac{1}{r} ( {M}_{M} {i}_{g} η - {K}_{B , HA} {p}_{B , HA} - ( 2 {J}_{R} + {J}_{M} {i}_{g}^{2} ) {\dot{ω}}_{R , HA} ) . \qquad equation ( 2.8 )$$

The longitudinal rigidity per axle results from

$${C}_{x , VA / HA} = \frac{Δ {F}_{x , n , VA / HA}}{{T}_{A}} \cdot \frac{1}{{\dot{λ}}_{VA / HA}} . \qquad Equation ( 2.9 )$$

An axlewise standardized lateral force can be calculated in approximation from the lateral acceleration of the front axle a_{y,VA} or rear axle a_{y,VA}.

$${F}_{y , n , VA} = \frac{{F}_{y , vl} + {F}_{y , vr}}{{F}_{z , vl} + {F}_{z , vr}} \\ = \frac{{F}_{y , VA}}{{F}_{z , VA}} \\ = \frac{{m}_{VA} {a}_{y , VA}}{{m}_{VA} g} \\ = \frac{{a}_{y , VA}}{g} \\ {F}_{y , n , HA} = \frac{{F}_{y , hl} + {F}_{y , hr}}{{F}_{z , hl} + {F}_{z , hr}} \\ = \frac{{F}_{y , HA}}{{F}_{z , HA}} \\ = \frac{{m}_{HA} {a}_{y , HA}}{{m}_{HA} g} \\ = \frac{{a}_{y , HA}}{g} \qquad equation ( 2.10 )$$

The lateral accelerations can be determined directly from the sensor information or calculated from derived signals such as the acceleration of the center of gravity by means of the yaw rate and yaw acceleration. The lateral tire stiffness per axle is achieved with the time derivative of the lateral acceleration with

$${C}_{y , VA / HA} = - \frac{{\dot{a}}_{y , VA / HA}}{g} \cdot \frac{1}{\dot{α}} \qquad equation ( 2.11 )$$

2.2 Criteria for Determining the Coefficient of Friction μₘₐₓ

The criterion for determining the coefficient of friction is fulfilled when one or more values of lateral tire stiffness fall below fixed threshold values Sₓ, S_{y}, that means
C_{x,j}<Sₓ,
C_{y,i}<S_{y},
i ε {1 . . . 4,VA,HA} equation (2.12)
2.3 Calculation of the Coefficient of Friction μₘₐₓ

When the criteria according to equation (2.17) are not fulfilled, there will be a standard specification for the coefficient of friction μₘₐₓ=μ₀. Otherwise, the maximum coefficient of friction can be determined from the utilization of grip and further auxiliary variables as will be described in the following.

Determination of the Utilization of Grip

The utilization of grip μ can be determined for each individual wheel according to

$$μ = \frac{\sqrt{{F}_{x}^{2} + {F}_{y}^{2}}}{{F}_{z}} \qquad equation ( 2.13 )$$

or axlewise with the vehicle mass m based on the approach
μ_{VA}F_{z,VA}+μ_{HA}F_{z,HA}=m \sqrt{aₓ²+a_{y}²} equation (2.14)
according to

$${μ}_{HA} = \frac{m \sqrt{{a}_{x}^{2} + {a}_{y}^{2}}}{{F}_{z , HA}} - {μ}_{VA} \frac{{F}_{z , VA}}{{F}_{z , HA}} , with \\ {μ}_{VA} = \frac{\sqrt{{F}_{x , VA}^{2} + {F}_{y , VA}^{2}}}{{F}_{z , VA}} \qquad equation ( 2.15 )$$

It applies for the special case that F_{x,VA} is small

$${μ}_{HA} = \frac{m \sqrt{{a}_{x}^{2} + {a}_{y}^{2}}}{{F}_{z , HA}} - \frac{\sqrt{{a}_{y , VA}^{2}}}{g} \cdot \frac{{F}_{z , VA}}{{F}_{z , HA}} . \qquad equation ( 2.16 )$$

For the front axle

$${μ}_{VA} = \frac{m \sqrt{{a}_{x}^{2} + {a}_{y}^{2}}}{{F}_{z , VA}} - {μ}_{HA} \frac{{F}_{z , HA}}{{F}_{z , VA}} , with \\ {μ}_{HA} = \frac{\sqrt{{F}_{x , HA}^{2} + {F}_{y , HA}^{2}}}{{F}_{z , HA}} \qquad equation ( 2.17 )$$

applies correspondingly.

It applies for the special case that F_{x,HA} is small

$${μ}_{VA} = \frac{m \sqrt{{a}_{x}^{2} + {a}_{y}^{2}}}{{F}_{z , VA}} - \frac{\sqrt{{a}_{y , HA}^{2}}}{g} \cdot \frac{{F}_{z , HA}}{{F}_{z , VA}} . \qquad equation ( 2.18 )$$

### 3 EMBODIMENT

The maximum coefficient of friction is estimated for each individual wheel by means of the lateral-force/tire-slip-angle gradient in the embodiment. The tire slip angle velocity is determined axlewise by means of

$$\dot{α} = \{ \begin{matrix}\frac{1}{{v}_{x}} ( {a}_{y} + {l}_{v} \ddot{ψ} ) - \dot{ψ} - \dot{δ} & for VA \\ \frac{1}{{v}_{x}} ( {a}_{y} - {l}_{h} \ddot{ψ} ) - \dot{ψ} & for HA\end{matrix} \qquad equation ( 3.1 )$$

The lateral-force/tire-slip-angle gradient at each wheel results in dependence on the threshold value Sₐ in the range of 0.5-5 degrees, preferably 1 degree/s with C_{y0} preferably 0.3 1/degree according to

$${C}_{y} = \{ \begin{matrix}\frac{Δ {F}_{y , n}}{{T}_{A} \dot{α}} & for \vert \dot{α} \vert \geq {S}_{a} \\ {C}_{y0} & for \vert \dot{α} \vert < {S}_{a}\end{matrix} \qquad equation ( 3.2 )$$

The lateral-force/tire-slip-angle gradient C_{y} is compared to the threshold value S_{y}. With C_{y}<S_{y}, and S_{y} being in the range of 0.02 to 0.06 1/degree, the maximum utilization of grip is determined for each individual wheel according to the relation

$$μ = \frac{\sqrt{{F}_{x}^{2} + {F}_{y}^{2}}}{{F}_{z}} .$$

The maximum coefficient of friction is determined according to

$${μ}_{max} = \{ \begin{matrix}{μ}_{k} & for \vert \dot{α} \vert \geq {S}_{α} \\ max ( {μ}_{k} , {μ}_{k - 1} ) & for \vert \dot{α} \vert < {S}_{α}\end{matrix} \qquad equation ( 3.3 )$$

The coefficient of friction μₖ is the actual utilization of grip at the sampling time k according to equation (2.13) in an analysis per wheel and equation (2.15) or (2.17) in an analysis per axle. The coefficient of friction μₖ₋₁ is the utilization of grip in the previous sampling time.

In the case of the axlewise analysis, the coefficient of friction μ_{max,VA/HA} along the vertical-force-responsive characteristic curve in FIG. 5 is distributed onto the wheels of the corresponding axle. This distribution takes into account that in a cornering maneuver the utilization of grip and, hence, also the maximum coefficient of friction at the relieved inside wheel is always higher than that at the loaded, outside wheel. The curve of distribution is non-linear, e.g. exponential. Depending on the wheel's relief from load or on its loading, a maximum coefficient of friction of e.g. 1.0 determined per axle must be taken into account on the curve inside with a value of 1.8 and on the curve outside with 0.9.

1-12. (canceled)

13. Method for determining a maximum coefficient of friction between tires and roadway of a vehicle from information about force occurring in the contact between tires and roadway,
wherein values are permanently determined which are representative of the utilization of grip in longitudinal and/or lateral direction, based on measured and/or estimated variables that represent the actual longitudinal forces, lateral forces and vertical forces acting upon the individual wheels and tires, while including measured or calculated actual state variables representative of the tire slip angle and/or the tire slip angle velocity and/or the longitudinal slip and/or the longitudinal slip velocity, and the determined values are compared to threshold values and sent to an evaluation unit for defining the maximum coefficient of friction by including further auxiliary variables such as longitudinal force, lateral force, vertical force, longitudinal acceleration, lateral acceleration, vehicle mass, and/or controlled variables when the comparison results fall below the threshold values.

14. Method as claimed in claim 13,
wherein the steps of determining gradients of the utilization of grip between tires and roadway in a longitudinal direction as a function of slip or slip velocity,
determining gradients of the utilization of grip between tires and roadway in a transverse direction as a function of the tire slip angle or the tire slip angle velocity,
comparing the gradients with threshold values and determining the maximum coefficient of friction from the longitudinal, lateral, vertical forces or the longitudinal forces, the vertical forces, the lateral acceleration, the longitudinal acceleration, the vehicle mass and/or controlled variables when the comparison result falls below the threshold values.

15. Method as claimed in claim 13,
wherein an equivalent value is used as the coefficient of friction when a comparison result prevails where the determined value does not fall below the threshold value.

16. Method as claimed in claim 14,
wherein the determination of the gradients from the longitudinal forces and/or lateral forces, standardized with the vertical forces, of at least one wheel or at least one vehicle axle and the tire slip angle or the tire slip angle velocity or the slip or the slip velocity of at least one wheel.

17. Method as claimed in claim 16,
wherein the determination of the gradients from the longitudinal force of at least one vehicle axle that is standardized with the vertical forces according to the relation
$$\begin{matrix}{C}_{x , VA / HA} = \frac{Δ {F}_{x , n , VA / HA}}{{T}_{A}} \cdot \frac{1}{{\dot{λ}}_{VA / HA}} with & equation ( 2.9 ) \\ {F}_{x , n , VA / HA} = \frac{{F}_{x , VA / HA}}{{F}_{z , VA / HA}} & equation ( 2.6 )\end{matrix}$$
wherein the longitudinal forces of the front axle of the vehicle are determined according to
$${F}_{x , VA} = \frac{1}{r} ( - {K}_{B , VA} {p}_{B , VA} - 2 {J}_{R} {\dot{ω}}_{R , VA} ) \qquad equation ( 2.7 )$$
and/or the longitudinal forces of the rear axle of the vehicle are determined according to
$${F}_{x , HA} = \frac{1}{r} ( {M}_{M} {i}_{g} η - {K}_{B , HA} {p}_{B , HA} - ( 2 {J}_{R} + {J}_{M} {i}_{g}^{2} ) {\dot{ω}}_{R , HA} ) . \qquad equation ( 2.8 )$$

18. Method as claimed in claim 16,
wherein the determination of the gradients from the lateral force of at least one vehicle axle standardized with the vertical forces according to the relation
$${C}_{y , VA / HA} = - \frac{{\dot{a}}_{y , VA / HA}}{g} \cdot \frac{1}{\dot{α}} . \qquad equation ( 2.11 )$$

19. Method as claimed in claim 14,
wherein the longitudinal-force/circumferential-slip gradients for at least one wheel are determined according to the relation
$${C}_{x} = \frac{\partial {F}_{x , n}}{\partial λ} = \frac{ⅆ {F}_{x , n}}{ⅆ t} \cdot \frac{ⅆ t}{ⅆ λ} \approx \frac{Δ {F}_{x , n}}{{T}_{A}} \cdot \frac{1}{\dot{λ}} . \qquad equation ( 2.3 )$$
and/or the lateral-force/tire-slip-angle gradients for at least one wheel are determined according to the relation
$${C}_{y} = - \frac{\partial {F}_{y , n}}{\partial α} = - \frac{ⅆ {F}_{y , n}}{ⅆ t} \cdot \frac{ⅆ t}{ⅆ α} \approx - \frac{Δ {F}_{y , n}}{{T}_{A}} \cdot \frac{1}{\dot{α}} . \qquad equation ( 2.5 )$$

20. Method as claimed in claim 13,
wherein the vertical forces are determined in a model-based fashion according to the relation
$$\begin{matrix}{F}_{z\_vl} = \frac{m}{( {l}_{v} + {l}_{h} )} ( {l}_{h} g - h {a}_{x} ) ( \frac{1}{2} - \frac{h}{( {b}_{vl} + {b}_{vr} ) g} {a}_{y} ) \\ {F}_{z\_vr} = \frac{m}{( {l}_{v} + {l}_{h} )} ( {l}_{h} g - h {a}_{x} ) ( \frac{1}{2} + \frac{h}{( {b}_{vl} + {b}_{vr} ) g} {a}_{y} ) \\ {F}_{z\_hl} = \frac{m}{( {l}_{v} + {l}_{h} )} ( {l}_{v} g + h {a}_{x} ) ( \frac{1}{2} - \frac{h}{( {b}_{hl} + {b}_{hr} ) g} {a}_{y} ) \\ {F}_{z\_hr} = \frac{m}{( {l}_{v} + {l}_{h} )} ( {l}_{v} g + h {a}_{x} ) ( \frac{1}{2} + \frac{h}{( {b}_{hl} + {b}_{hr} ) g} {a}_{y} )\end{matrix} \qquad equation ( 2.2 )$$

21. Method as claimed in claim 13,
wherein the maximum utilization of grip is determined for each individual wheel according to the relation
$$μ = \frac{\sqrt{{F}_{x}^{2} + {F}_{y}^{2}}}{{F}_{z}} . \qquad equation ( 2.13 )$$

22. Method as claimed in claim 13,
wherein the maximum utilization of grip is determined per axle according to the relation
$$\begin{matrix}{μ}_{HA} = \frac{m \sqrt{{a}_{x}^{2} + {a}_{y}^{2}}}{{F}_{z , HA}} - {μ}_{VA} \frac{{F}_{z , VA}}{{F}_{z , HA}} , with \\ {μ}_{VA} = \frac{\sqrt{{F}_{x , VA}^{2} + {F}_{y , VA}^{2}}}{{F}_{z , VA}}\end{matrix} \qquad equation ( 2.15 )$$
for the rear axle of the vehicle, or
$$\begin{matrix}{μ}_{VA} = \frac{m \sqrt{{a}_{x}^{2} + {a}_{y}^{2}}}{{F}_{z , VA}} - {μ}_{HA} \frac{{F}_{z , HA}}{{F}_{z , VA}} , with \\ {μ}_{HA} = \frac{\sqrt{{F}_{x , HA}^{2} + {F}_{y , HA}^{2}}}{{F}_{z , HA}}\end{matrix} \qquad equation ( 2.17 )$$
for the front axle of the vehicle.

23. Method as claimed in claim 13, wherein the steps of
determining the tire slip angle velocity \dot{α} at the front and rear axle of the vehicle in accordance with the lateral acceleration a_{y}, the longitudinal speed νₓ, the yaw acceleration \ddot{ψ}, the yaw rate \dot{ψ}, the steering angle velocity \dot{δ} and/or the distance between the center of gravity and the front axle l ᵥ or the rear axle lₕ,
comparing the tire slip angle velocity \dot{α} with threshold values S_{y,a},
determining the lateral-force/tire-slip-angle gradients C_{y} at each wheel in dependence on the comparison result |\dot{a}|≧S_{y,a}, |\dot{a}|<S_{y,a}
determining the maximum coefficient of friction μₘₐₓ according to the relations for the maximum utilization of grip (equations 2.13, 2.15, 2.17), when C_{y}<S_{y}.

24. Microcontroller program product which can be loaded directly into the memory of a driving dynamics control, such as ESP, TCS, ABS control, and like systems and comprises software code sections by means of which the steps according to claim 13 are implemented when the product operates on a microcontroller.

25. Method as claimed in claim 16,
wherein the longitudinal-force/circumferential-slip gradients for at least one wheel are determined according to the relation
$${C}_{x} = \frac{\partial {F}_{x , n}}{\partial λ} = \frac{ⅆ {F}_{x , n}}{ⅆ t} \cdot \frac{ⅆ t}{ⅆ λ} \approx \frac{Δ {F}_{x , n}}{{T}_{A}} \cdot \frac{1}{λ} . \qquad equation ( 2.3 )$$
and/or the lateral-force/tire-slip-angle gradients for at least one wheel are determined according to the relation
$${C}_{y} = - \frac{\partial {F}_{y , n}}{\partial α} = - \frac{ⅆ {F}_{y , n}}{ⅆ t} \cdot \frac{ⅆ t}{ⅆ α} \approx \frac{Δ {F}_{y , n}}{{T}_{A}} \cdot \frac{1}{α} . \qquad equation ( 2.5 )$$

26. Method as claimed in claim 14, wherein the steps of
determining the tire slip angle velocity \dot{α} at the front and rear axle of the vehicle in accordance with the lateral acceleration a_{y}, the longitudinal speed νₓ, the yaw acceleration \ddot{ψ}, the yaw rate \dot{ψ}, the steering angle velocity \dot{δ} and/or the distance between the center of gravity and the front axle lᵥ or the rear axle lₕ,
comparing the tire slip angle velocity &i with threshold values S_{y,a},
determining the lateral-force/tire-slip-angle gradients C_{y} at each wheel in dependence on the comparison result |\dot{a}|≧S_{y,a}, |\dot{a}|<S_{y,a}
determining the maximum coefficient of friction μₘₐₓ according to the relations for the maximum utilization of grip (equations 2.13, 2.15, 2.17), when C_{y}<S_{y}.
